(19) United States
(12) Patent Application Publication
(10) Pub. No.: US 2022/0388563 A1
(43) Pub. Date: Dec. 8, 2022

(54) MODULAR STEERING WHEEL ASSEMBLY

(71) Applicant: Super ATV, LLC, Madison, IN (US)

(72) Inventor: Marcelo DANZE, Aliso Viejo, CA (US)

(21) Appl. No.: 17/833,712

(22) Filed: Jun. 6, 2022

Related U.S. Application Data
(60) Provisional application No. 63/202,285, filed on Jun. 4, 2021.

(51) Int. Cl. B62D 1/04; B62D 1/06; B62D 1/08

(52) U.S. Cl. CPC B62D 1/046; B62D 1/06; B62D 1/08

(57) ABSTRACT

A motor vehicle can include a steering hub mechanism and a steering wheel, the steering wheel can include an outer rim, a center section, and one or more modular accessories, and can include a first modular accessory configured to be fixed to the outer rim and a second modular accessory configured to be fixed to the outer rim, where the first modular accessory differs from the second modular accessory with respect to one or more of material, physical appearance, and/or a control function. The steering wheel can include one or more interchangeable spokes configured to be fixed to the center section and the outer rim, wherein said interchangeable spokes define the depth of the outer rim relative to the center section. The one or more interchangeable spokes comprise one or more control mechanisms, the control mechanisms being configured to attach to one or more attachment points of the outer rim.

### CROSS REFERENCE TO RELATED APPLICATIONS

This application claims priority to U.S. Provisional Application No. 63/202,285, filed Jun. 4, 2021, the entire disclosure of which is herein expressly incorporated by reference.

### BACKGROUND

### Field of the Disclosed Embodiments

The present disclosure relates to a steering wheel assembly in a motor vehicle, and more particularly to a steering wheel having modular spokes and accessories.

### Description of the Related Art

Conventional steering wheels may be configured to operate a motor vehicle and to perform control functions for various devices thereof. However, a conventional steering wheel is typically a unitary mechanism that is not configurable or changeable for customization by a user.

### BRIEF SUMMARY OF THE DISCLOSED EMBODIMENTS

Embodiments described herein include a modular vehicle steering wheel assembly that allows for the removal and replacement of the spokes connecting the outer rim to the center section. These removable spokes allow for the “end user” to customize the individual look of the wheel assembly. Additionally, the outer rim has multiple accessory attachment points allowing for individual customization.

In some embodiments, a motor vehicle can include a steering hub mechanism, and a steering wheel, the steering wheel can include an outer rim, a center section, and one or more modular accessories, and can include a first modular accessory configured to be fixed to the outer rim, and a second modular accessory configured to be fixed to the outer rim, where the first modular accessory differs from the second modular accessory with respect to one or more of material composition, physical appearance and/or a control function.

The motor vehicle can include a steering wheel, which steering wheel further can include one or more interchangeable spokes configured to be fixed to the center section and the outer rim, where the one or more interchangeable spokes defines the depth of the outer rim relative to the center section. The one or more interchangeable spokes include one or more control mechanisms, the control mechanisms being configured to attach to one or more attachment points of the outer rim.

The one or more control mechanisms include one or more control pads positioned for operation by fingertips of a driver on the steering wheel and configured to operably connect to one or more devices operably connected to the motor vehicle.

The motor vehicle can include devices selected from a group consisting of an audio device, illumination device, air conditioner, heater, defroster, telephone, voice control module, cruise control module, window controls, and windshield wipers, to name just a few non-limiting examples. The motor vehicle can include the one or more control pads configured to be operably connected to the corresponding one or more devices via a wiring embedded on or within a steering hub mechanism.

The motor vehicle can include the control mechanism positioned on a forward side of the one or more interchangeable spokes, facing a driver relative to said outer rim. The motor vehicle can include the control mechanism positioned on a rear side of the one or more interchangeable spokes, opposite a driver relative to said outer rim. The control mechanisms can be located at a predetermined positions on said one or more interchangeable spokes.

### BRIEF DESCRIPTION OF THE DRAWINGS/FIGURES

FIG. 1 is an illustration of a steering wheel assembly, according to some embodiments.

FIG. 2 is an illustration of a steering wheel, according to some embodiments.

FIG. 3 is an illustration of a steering wheel, according to some embodiments.

FIG. 4 is an illustration of a steering wheel, according to some embodiments.

### DETAILED DESCRIPTION OF THE DISCLOSED EMBODIMENTS

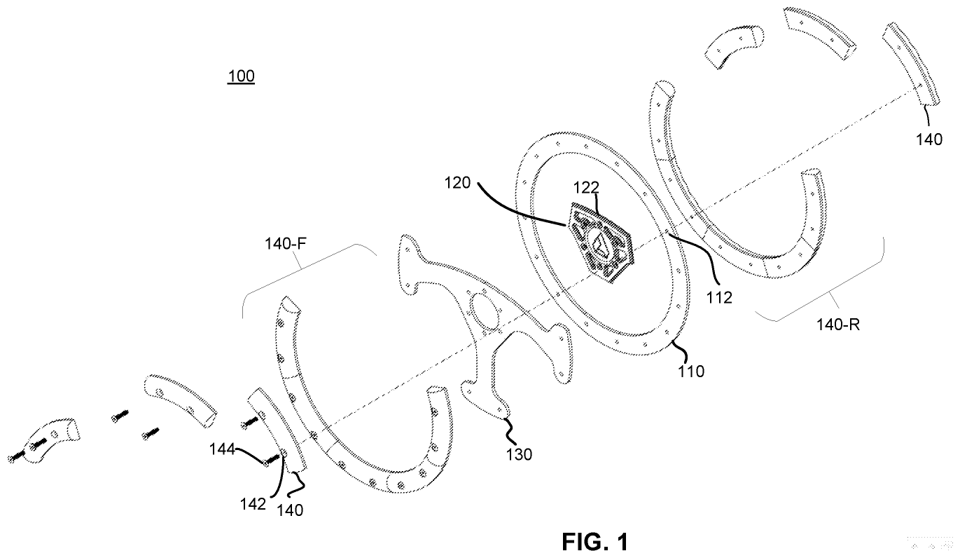

FIG. 1 illustrates a steering wheel 100 for a transportation device, such as a motor vehicle, according to some embodiments. Referring to FIG. 1, steering wheel 100 includes an outer rim 110 having multiple attachment points 112 and center section 120 having multiple attachment points 122. The attachment points 112 and 122 are configured to permit one or more spokes 130 to be mounted to the outer rim 110 and the center section 120, respectively. Attachment points 112 are further configured to permit one or more accessory modules 140 to be mounted to rim 110 to enhance the look and/or function of the complete steering wheel 100 assembly.

According to some embodiments, spokes 130 and rim 110 can comprise one or more modular accessories. In some exemplary embodiments, the one or more modular accessories can include, but are not limited to, various grip styles, electronic switches, button mounts, handles, etc. In some embodiments, the one or more modular accessories can function as control devices that include one or more control pads positioned for operation by fingertips of a driver on the steering wheel. In some embodiments, the control devices are configured to control one or more devices operably connected to the motor vehicle. In some embodiments, the devices can include one or more of an audio device, illumination device, air conditioner, heater, defroster, telephone, voice control module, cruise control module, window controls, and windshield wipers, to name just a few non-limiting examples.

According to some embodiments, modular accessories 140 can include an arrangement 140-F assembled on a front surface of rim 110. According to some embodiments, modular accessories 140 can additionally or alternatively include an arrangement 140-R assembled on a rear surface of rim 110. According to some embodiments, control devices can be located at predetermined positions on at least one of the interchangeable spokes 130 and/or on the one or more modular accessories 140. According to some embodiments, interchangeable spokes 130 can be swapped out to adjust the depth of the rim 110 relative to the center section 120.

According to some embodiments, modular accessories 140 can include one or more attachment points 142 to connect said accessory modules 140 to one or more of outer rim 110, center section 120, and spokes 130.

For example, attachment points 142 can be arranged as vias extending through one or more accessory modules 140 and aligned to attachment points 112 of rim 110. Thereby, attachment points 142 are configured to permit one or more accessory modules 140 to be mounted to rim 110 to enhance the appearance and/or function of steering wheel 100. According to some embodiments, attachment points arranged as vias 142 can additionally extend through one or more of spokes 130. Thereby, attachment points 142 can be configured to permit one or more spokes 130 to be mounted.

According to some embodiments, accessory modules 140 and/or spokes 130 can be mounted to rim 110 through attachment points 142, 132, 122, and 112 by fixing one or more of a screw, a bolt, a pin, a latch, a clip, a lock, a friction fit, and the like, through the aligned vias. According to some embodiments, steering wheel 100, including outer rim 110, can be arranged in a circular shape, a butterfly shape, or any other shape.

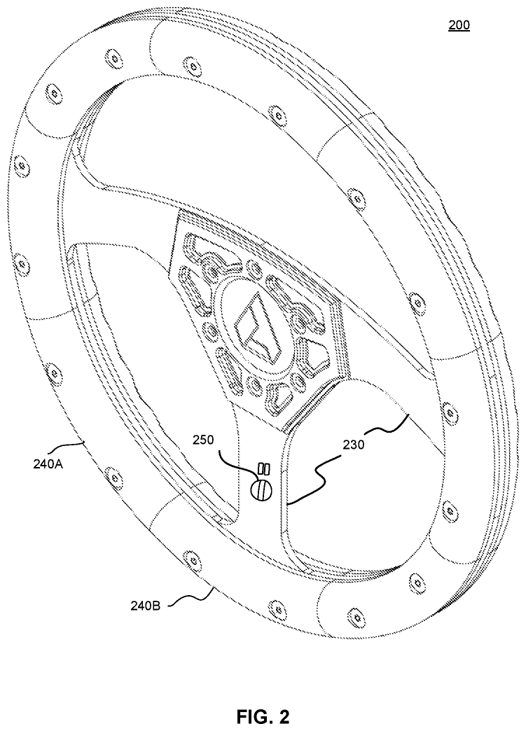

FIG. 2 illustrates a steering wheel 200 for a transportation device, according to some embodiments. Steering wheel 300 can be an embodiment of steering wheel 200. Referring to FIG. 2, according to some embodiments, modular accessories 240A can vary from one or more modular accessories 240B. According to some embodiments, modular accessories 240A and 240B can vary from one another in color, texture, grip style, and/or material, to name just a few non-limiting examples.

According to some embodiments, interchangeable spokes 230 can include one or more control pads 250 positioned for operation by finger(s) of a driver on steering wheel 200. In some embodiments, control pads 250 are configured to control one or more devices operably connected to the motor vehicle. In some embodiments, the devices can include one or more of an audio device, illumination device, air conditioner, heater, defroster, telephone, voice control module, cruise control module, window controls, and windshield wipers, to name just a few non-limiting examples. In one non-limiting example, control pads 250 can include controls for various wiping speeds, e.g., one control for “slow” wiping action, another one for “medium”, and another one for “fast”. In another non-limiting example, control pads 250 can include separate controls for engaging, disengaging, and setting characteristics of a cruise-control function of the motor vehicle, such as a following distance of an adaptive cruise control function of the motor vehicle.

Control pads 250 can include rollers, buttons, and switches, to name just a few non-limiting examples. Control pads 250 can project from a surface of interchangeable spokes 230 and/or modular accessory 240A/240B or be positioned in a recess/depression. In some embodiments, control pads 250 can be conveniently located on one or more interchangeable spokes 230, as shown. In some embodiments, control pads 250 can be additionally or alternatively located on a gripping member, such as one or more modular accessories 240A and/or 240B. In some embodiments, control pads 250 can be located on an arrangement (e.g., 140-F) assembled on a front surface of rim 110 and/or spokes 130. In some embodiments, control pads 250 can be located on an arrangement 140-R assembled on a rear surface of rim 110 and/or spokes 130. In some embodiments, control pads 250 can be positioned on the hub-like center section 120. Control pads 250 can include any suitable kind of control mechanism, e.g., piezoelectric, capacitive, touch-sensitive, pressure-sensitive, and heat-sensitive, to name just a few non-limiting examples.

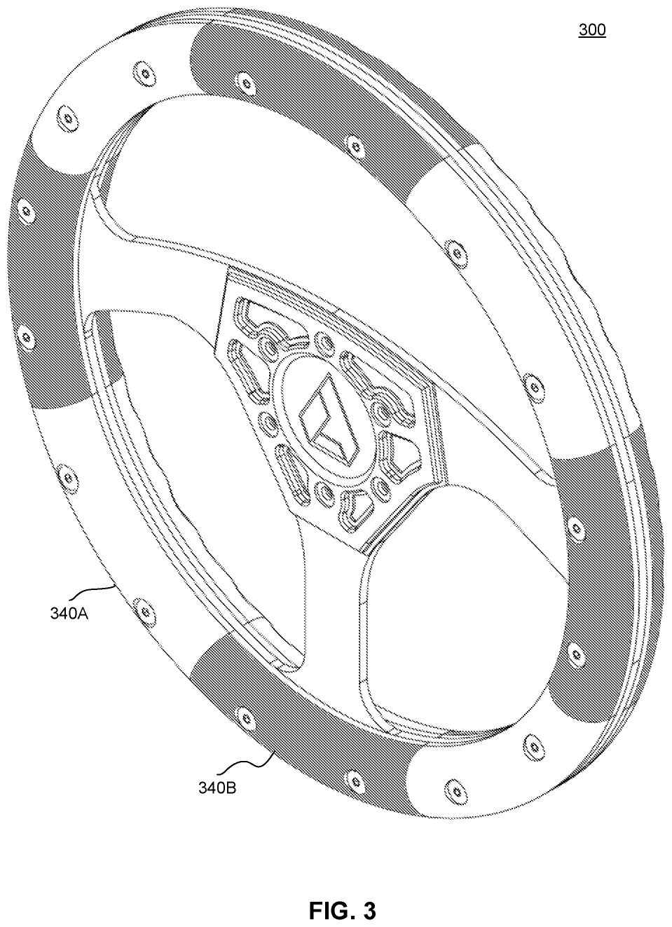

FIG. 3 illustrates a steering wheel 300 for a transportation device, according to some embodiments. Steering wheel 300 can correspond to one or more embodiments of steering wheel 100 and/or 200. Referring to FIG. 3, steering wheel 300 includes modular accessories 340A and 340B mounted to an outer rim (e.g., outer rim 110) and center section 120 having multiple attachment points to enhance the physical appearance of the steering wheel 300 assembly. According to some embodiments, modular accessories 340A and 340B can vary from one another in color, texture, grip style, and/or material, to name just a few non-limiting examples. For example, modular accessories 340A can include a blue grip portion while modular accessories 340B can include a white grip portion. Or, for example, modular accessories 340A can include a leather grip portion, while modular accessories 340B can include a microfiber grip portion. In some examples, modular accessories 340A and 340B can vary the use of materials, such as leather materials, synthetic resins, polyurethane, faux-leather, plastic, wood, and/or microfiber, to name just a few non-limiting examples. These examples are non-limiting, and any arrangement of appearance and/or functional characteristics can be variously implemented by modular accessories 340A and 340B.

According to some embodiments, steering wheel 300 can be configured to optimize the grip of a driver's fingers and to enhance control of the motor vehicle. For example, one or more modular accessories 340A and/or 340B can be selected and implemented to optimize proper posture of the hand-arm system. In one non-limiting example, one or more modular accessories 340A and/or 340B can be selected and implemented to optimize a neutral or straight angle of flexion of a driver's wrist to avoid overexertion of such tissues as tendons and tendon sheaths and compression of nerves and blood vessels.

As above, in some embodiments steering wheel 300 can include one or more interchangeable spokes 330 and/or one or more modular accessories 340A and 340B mounted to an outer rim 110 having control pads 250 configured to control one or more devices operably connected to the motor vehicle. In some embodiments, the devices can include one or more of an audio device, illumination device, air conditioner, heater, defroster, telephone, voice control module, cruise control module, window controls, and windshield wipers, to name just a few non-limiting examples. Control pads 250 can be conveniently located on a gripping member.

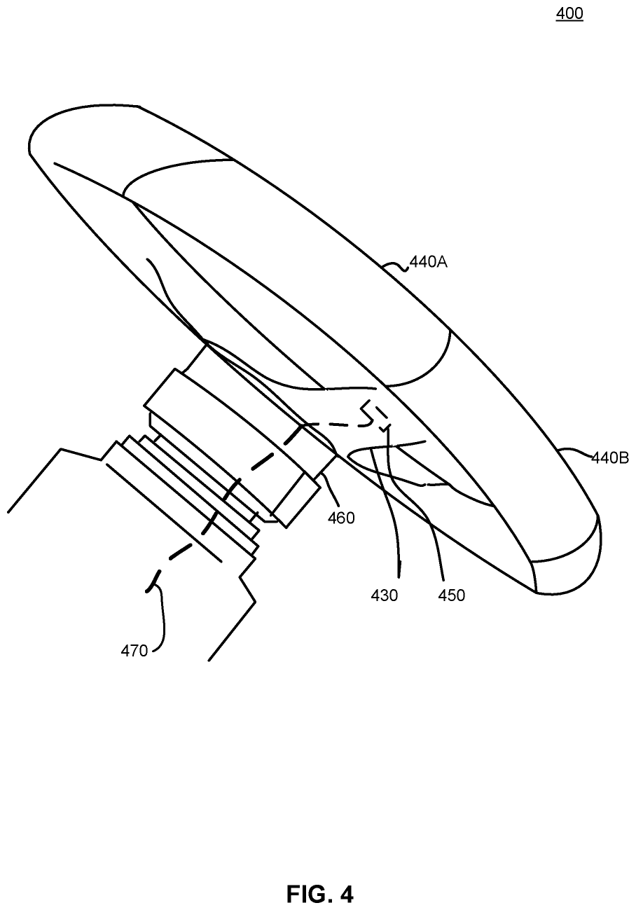

FIG. 4 illustrates a steering wheel 400 for a transportation device, such as a motor vehicle, according to some embodiments of the invention. Referring to FIG. 4, steering wheel 400 can correspond to one or more embodiments of steering wheel 100, 200, and/or 300.

According to some embodiments, a motor vehicle can include steering wheel 400 coupled with steering hub mechanism 460 supporting the steering wheel 400. Steering hub mechanism 460 can include one or more link members integrating the steering hub mechanism on a vehicle body. In some embodiments, steering wheel 400 can be mounted to a motor vehicle steering column by steering hub mechanism 460. Steering hub 460 can be connected to one or more of outer ring 110, center section 120, one or more spokes 130, or any other portion of steering wheel 400.

According to some embodiments, steering wheel 400 in addition to its use in steering, can include one or more mechanisms to activate a horn, paddle-shifter mechanisms, and/or other controls as described above, such as control pad 450 to perform functions corresponding to audio device, illumination device, air conditioner, heater, defroster, telephone, voice control module, cruise control module, window controls, and windshield wipers, etc. Such controls can be operably connected to the corresponding device via a wiring or bus 470, which may be embedded on or within steering hub mechanism 460.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A steering wheel for a motor vehicle, comprising:
an outer rim;
a center section; and
one or more modular accessories, comprising:
a first modular accessory configured to be fixed to one or more of the outer rim and the center section, and
a second modular accessory configured to be fixed to the outer rim, wherein the first modular accessory differs from the second modular accessory with respect to one or more of: material composition, physical appearance and/or a control function.

2. A steering wheel of claim 1, further comprising one or more interchangeable spokes configured to be releasably fixed to the center section and the outer rim, wherein the one or more interchangeable spokes defines the depth of the outer rim relative to the center section.

3. A steering wheel of claim 2, wherein the one or more interchangeable spokes comprise one or more control mechanisms, the control mechanisms being configured to attach to one or more attachment points of the outer rim.

4. A steering wheel of claim 3, wherein the one or more control mechanisms include one or more control pads positioned for operation by fingertips of a driver on the steering wheel and configured to operably connect to one or more devices operably connected to the motor vehicle.

5. A steering wheel of claim 4, wherein said devices are selected from a group consisting of an audio device, illumination device, air conditioner, heater, defroster, telephone, voice control module, cruise control module, window controls, and windshield wipers.

6. A steering wheel of claim 5 wherein said one or more control pads are configured to be operably connected to the corresponding one or more devices via a wiring, wherein the wiring is configured to be embedded on or within a steering hub mechanism of the motor vehicle.

7. A steering wheel of claim 3, wherein said control mechanism is positioned on a forward side of the one or more interchangeable spokes, facing a driver relative to said outer rim.

8. A steering wheel of claim 3, wherein said control mechanism is positioned on a rear side of the one or more interchangeable spokes, opposite a driver relative to said outer rim.

9. A steering wheel of claim 3, wherein said control mechanisms are located at a predetermined position on said one or more interchangeable spokes.

10. A motor vehicle comprising:
A steering hub mechanism; and
a steering wheel, the steering wheel comprising:
an outer rim;
a center section; and
one or more modular accessories, comprising:
a first modular accessory configured to be fixed to one or more of the outer rim and the center section, and
a second modular accessory configured to be fixed to the outer rim, wherein the first modular accessory differs from the second modular accessory with respect to one or more of: material composition, physical appearance and/or a control function

11. The motor vehicle of claim 10, the steering wheel further comprising one or more interchangeable spokes configured to be fixed to the center section and the outer rim, wherein the one or more interchangeable spokes defines the depth of the outer rim relative to the center section.

12. The motor vehicle of claim 10, wherein the one or more interchangeable spokes comprise one or more control mechanisms, the control mechanisms being configured to attach to one or more attachment points of the outer rim.

13. The motor vehicle of claim 12, wherein the one or more control mechanisms include one or more control pads positioned for operation by fingertips of a driver on the steering wheel and configured to operably connect to one or more devices operably connected to the motor vehicle.

14. The motor vehicle of claim 13, wherein said devices are selected from a group consisting of an audio device, illumination device, air conditioner, heater, defroster, telephone, voice control module, cruise control module, window controls, and windshield wipers.

15. The motor vehicle of claim 14 wherein said one or more control pads are configured to be operably connected to the corresponding one or more devices via a wiring embedded on or within a steering hub mechanism.

16. The motor vehicle of claim 12, wherein said control mechanism is positioned on a forward side of the one or more interchangeable spokes, facing a driver relative to said outer rim.

17. The motor vehicle of claim 12, wherein said control mechanism is positioned on a rear side of the one or more interchangeable spokes, facing a driver relative to said outer rim.

18. The motor vehicle of claim 12, wherein said control mechanisms are located at a predetermined positions on said one or more interchangeable spokes.
